(19) United States
(12) Patent Application Publication
(10) Pub. No.: US 2025/0354413 A1
(43) Pub. Date: Nov. 20, 2025

(54) Method for Controlling the Deployment of a Flush Door Handle of a Vehicle, a Control Unit, a Computer Program Product, and a Storage Medium

(71) Applicant: Robert Bosch GmbH, Stuttgart (DE)

(72) Inventor: Jue Xu, Suzhou (CN)

(21) Appl. No.: 19/206,588

(22) Filed: May 13, 2025

(30) Foreign Application Priority Data
May 14, 2024 (CN) 2024 1059 8012.2

(51) Int. Cl. E05B 77/02; E05B 85/10

(52) U.S. Cl. CPC E05B 77/02; E05B 85/103

(57) ABSTRACT

A method for controlling the deployment of a flush door handle of a vehicle, a control unit, a computer program product, and a storage medium are disclosed. The method is suitable for controlling the deployment of a flush door handle used in a vehicle, wherein the flush door handle is equipped with a motor. The method includes (i) a vehicle collision prediction step, wherein in response to the vehicle being started, external vehicle driving information is acquired in real time by way of sensors installed on the vehicle and it is determined by calculation whether there is a predetermined vehicle collision risk or it is determined whether there is a predetermined vehicle collision risk based on a signal related to the vehicle collision risk from the vehicle, and (ii) a collision pre-trigger step, wherein when it is determined that there is a predetermined vehicle collision risk, the operation of the motor of the flush door handle is triggered to change the flush door handle from a flush state to a deployed state. By way of the above, the issue is addressed that a flush door handle of a vehicle may fail to deploy due to power failure during a vehicle collision.

This application claims priority under 35 U.S.C. § 119 to application no. CN 2024 1059 8012.2, filed on May 14, 2024 in China, the disclosure of which is incorporated herein by reference in its entirety

The present application belongs to the field of vehicle control technology, and relates to a control strategy for the deployment of a flush door handle of a vehicle, and in particular to a method for controlling the deployment of a flush door handle of a vehicle as well as a corresponding control unit, computer program product, and computer-readable storage medium.

### BACKGROUND

As automotive technology and design continue to advance, flush door handles are an emerging trend in current vehicle (especially but not limited to electric vehicle) design. They not only meet aesthetic requirements, but also improve the aerodynamic performance of the entire vehicle.

The flush door handle is usually located on the door surface of the vehicle and can be integrated with the vehicle body instead of protruding separately. It is usually in a hidden (also called retracted or folded) state and can be popped out (or opened) when needed to open the door. This design provides a more streamlined appearance and reduces air resistance, improving vehicle energy efficiency. In addition, the flush door handle improves the overall aesthetics of the vehicle, making it look more sleek and modern.

However, the use of flush door handles also presents some technical challenges, one of which is the problem that they cannot deploy after power failure. In short, since flush door handles usually rely on electricity to drive a motor to deploy the flush door handle when needed, when a collision occurs and causes a power outage, the flush door handle may not be able to deploy automatically, resulting in people outside the vehicle being unable to perform emergency rescue on the occupants inside the vehicle.

### SUMMARY

In view of the above background, the purpose of the present application is to propose a method for controlling the deployment of a flush door handle of a vehicle, which can effectively solve the problem that flush door handles of vehicles may not deploy due to power failure during vehicle collisions.

The purpose of the present application is also to propose a control unit, computer program product, and computer-readable storage medium corresponding to the above described control method.

To this end, according to one aspect of the present application, a method for controlling the deployment of a flush door handle of a vehicle is provided, which is suitable for controlling the deployment of a flush door handle used in a vehicle, wherein the flush door handle is equipped with a motor (also referred to as a drive motor) and the method comprises:

a vehicle collision prediction step, wherein in response to the vehicle being started, external vehicle driving information is obtained in real time by way of sensors installed on the vehicle and it is determined if a predetermined vehicle collision risk is present by calculation or if a predetermined vehicle collision risk is present based on a signal from the vehicle associated with the vehicle collision risk; and a collision pre-trigger step, wherein the operation of the motor of the flush door handle is triggered to transition the flush door handle from the flush state (or typically the initial state) to the deployed state under circumstances where a predetermined vehicle collision risk is determined to be present.

According to another aspect of the present application, a control unit adapted to implement the method for controlling the deployment of a flush door handle of a vehicle as described above is provided so as to control the deployment of a flush door handle used in a vehicle, wherein the flush door handle is equipped with a motor and the control unit comprises:
a vehicle collision prediction module, which is configured in response to the vehicle being started to obtain external vehicle driving information in real time by way of sensors installed on the vehicle and determine if a predetermined vehicle collision risk is present by calculation or if a predetermined vehicle collision risk is present based on a signal from the vehicle associated with the vehicle collision risk; and
a collision pre-trigger module, which is configured to trigger the operation of the motor of the flush door handle to transition the flush door handle from the flush state to the deployed state under circumstances where a predetermined vehicle collision risk is determined to be present.

According to another aspect of the present application, a computer program product is also proposed, which comprises a computer program (or instruction), and when the computer program is executed by a processor, the method for controlling the deployment of a flush door handle of a vehicle as described above is implemented.

According to yet another aspect of the present application, a computer-readable storage medium (or machine-readable storage medium) is also proposed, which stores executable instructions (or program instructions), and when the executable instructions are executed by a processor, the processor implements the method for controlling the deployment of a flush door handle of a vehicle as described above.

As can be seen from the above description, the present application predicts a vehicle collision in advance of a possible vehicle collision and performs a collision pre-trigger in advance based on the prediction result (which can thus have a collision pre-trigger step/stage and a collision pre-trigger step/stage) so that the flush door handle can be popped out (or unlocked) early when a vehicle collision is likely to occur, thereby reliably avoiding the problem of the flush door handle failing to deploy normally due to power failure during a vehicle collision in a simple and low-cost manner.

### BRIEF DESCRIPTION OF THE DRAWINGS

The features, advantages, and other aspects of the present application will be more clearly understood through the following more detailed description of the present application with reference to the accompanying drawings and in combination with exemplary examples. In the accompanying drawings:

FIG. 1 is a basic logic or flow chart of a method for controlling a flush door handle of a vehicle to deploy according to an exemplary example of the present application;

FIG. 2 is a schematic diagram showing the composition of a control unit according to an exemplary example of the present application.

### DETAILED DESCRIPTION

The specific examples of the present application and other details are described in detail below with reference to the accompanying drawings. It will be understood that the examples given herein and their related descriptions shall be understood to be exemplary and not to constitute a limitation to the present application.

Further, it is to be noted that for simplicity and for a more convenient understanding of the design elements or substantive features of the present application, the specification of this application and the accompanying drawings thereof highlight or illustrate content related to the main design elements or principles of the present application while omitting or simplifying the content of other parts. With regard to the basic principles, control processes, specific details, etc. of these omitted parts, they belong to known technologies in this field or those skilled in the art can make specific applications based on existing knowledge, application environment, etc. and they will not be repeated here or illustrated in detail. In other words, methods (e.g., control processes), techniques, etc. that are well-known in the art are not illustrated or described in detail to avoid unnecessarily obscuring the core or essence of the present application.

First, as described in the background technology section of the present application, there are problems in the prior art such as the flush door handle of a vehicle failing to deploy due to power failure during vehicle collisions and no effective way to solve this problem have been found so far.

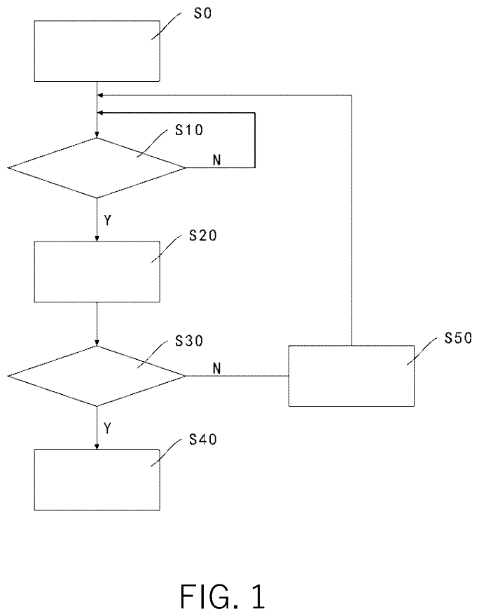

Based on the above background, as shown in FIG. 1, according to an exemplary example of the present application, an improved method for controlling the deployment of a flush door handle of a vehicle is proposed, and its basic principle (working process) or control logic is roughly summarized as follows:

The present application proposes a method for controlling the deployment of a flush door handle of a vehicle that is suitable for controlling the deployment of a flush door handle used in a vehicle, wherein the flush door handle is typically equipped with a motor and the method comprises:
a vehicle collision prediction step S10, wherein in response to the vehicle being started (vehicle activation step S0), external vehicle driving information (including but not limited to vehicle driving speed, distance between the vehicle and another vehicle or obstacle, etc.) is obtained in real time by way of sensors installed on the vehicle (including but not limited to ultrasonic sensors, radars, cameras, etc.) and a determination if a predetermined vehicle collision risk is present is made by calculation (i.e., a determination is made by a preset decision logic) or a determination if a predetermined vehicle collision risk is present is made based on a signal from the vehicle associated with the vehicle collision risk (including but not limited to a signal on a CAN bus of the vehicle); and
a collision pre-trigger step S20, wherein the operation of the motor of the flush door handle is triggered to transition the flush door handle from the flush state to the deployed state under circumstances where a predetermined vehicle collision risk is determined to be present.

In combination with the above description, it can be seen that the method according to the present application may comprise at least the following steps (or stages):

1) Vehicle collision prediction step S10

After the vehicle is activated normally, the vehicle collision prediction step S10 (or vehicle collision prediction stage) can be entered, that is, vehicle collision prediction can be performed in real time, wherein the required external vehicle driving information can be obtained in real time with the help of various sensors installed on the vehicle and the determination of whether a predetermined vehicle collision risk is present can be made by calculation with a preset decision logic. In particular, relevant measurements and vehicle collision risk determination can be made with the help of various existing auxiliary driving systems or functions configured in the vehicle in the same or similar manner; or it is also possible to directly use a signal from the vehicle related to vehicle collision risk to determine whether a predetermined vehicle collision risk is present. As a non-limiting example, after the vehicle is activated normally, a mainstream auxiliary driving system in the current market, i.e., an AEB (automatic emergency braking) system, can start working, using the external vehicle driving information obtained by the relevant sensors to calculate the vehicle collision risk and send the relevant information in the form of an output signal. The present application can directly use the output signal to determine whether a predetermined vehicle collision risk is present based on a predetermined decision logic;

2) Collision pre-trigger step S20

After determining that a predetermined vehicle collision risk is present, the collision pre-trigger step S20 (or collision pre-trigger stage) can be entered. During this period, for example, a “deployment” request can be sent to the door handle control unit of the flush door handle through a vehicle communication network (including but not limited to a vehicle network). After receiving the “deployment” request, the door handle control unit can drive the motor to run to trigger the deployment of the door handle, thereby changing the flush door handle from a flush state to a deployed state. Because at this time

it is in the stage where the collision has not yet occurred, that is, the collision may occur but has not actually occurred, the power supply and communication of the flush door handle are working normally. If there are no other faults, the flush door handle can usually enter the deployed state normally.

It is to be noted that it is known in the art that under the current state of technology, most vehicles are configured with an AEB (automatic emergency braking) system, and the following two mainstream risk assessment models are typically adopted for the control strategy based on the AEB system: the safety distance model and TTC (time to collision) model. Both of the above models use sensors to obtain external vehicle driving information in real time and then determine the vehicle's current collision risk through calculation. In the safety distance model, the movement information of the vehicle itself and surrounding vehicles or obstacles are combined to calculate the warning distance and emergency braking distance in real time and compare them with the actual vehicle distance. When the actual vehicle distance is less than the warning distance and emergency braking distance in the current state, corresponding warning and emergency braking measures are taken; in the TTC model, the estimated time to collision is calculated based on the relative distance, relative speed, and other information between the vehicle itself and surrounding vehicles or obstacles and compared with the preset warning time threshold and emergency braking time threshold. When the estimated time to collision is less than the preset warning time threshold or emergency braking time threshold, corresponding control actions are taken.

To facilitate a clearer understanding of the technical solutions and design principles of the present application, in the following description, the various steps in the example shown in FIG. 1 of the present application will be explained or described in detail using the TTC model as an example, but it is clearly not limited to this.

More specifically, when the design of the control strategy employs the TTC model, the vehicle collision prediction step S10 may comprise: calculating the expected time to collision TTC based on the relative distance and relative velocity between the vehicle itself and another vehicle or obstacle and comparing the expected time to collision TTC to a preset vehicle collision warning time threshold Ts and determining that a predetermined vehicle collision risk is present when the expected time to collision TTC is less than or equal to the vehicle collision warning time threshold Ts.

In other words, as shown in FIG. 1, typically, after the vehicle is activated (i.e., vehicle activation step S0), especially after the vehicle door is closed and normal driving begins, the vehicle collision prediction step S10 may be entered. At this point, the state of the flush door handle generally defaults to the hidden (or retracted) state, i.e., the door handle is hidden in the vehicle door, thereby reducing wind resistance during driving.

In the vehicle collision prediction step S10, for example, real-time vehicular collision prediction may be continuously performed under the control of a central control unit of the vehicle. That is, external vehicle driving information can be obtained in real time and the obtained information can be used to predict the vehicle collision, wherein when the estimated time to collision TTC is less than or equal to the vehicle collision warning time threshold Ts (that is, the judgment result is Y), the subsequent steps (such as the collision pre-trigger step S20, triggering the flush door handle so it pops out) can be performed;

When the estimated time to collision TTC is greater than the vehicle collision warning time threshold T (s, that is, the judgment result is N), the external vehicle driving information can continue to be acquired in real time before returning to and repeating the vehicle collision prediction step S10.

Advantageously, the vehicle collision prediction step S10 can be implemented by way of a central control unit of the vehicle, the collision pre-trigger step can be implemented by way of a door handle control unit (such as a vehicle body domain controller) of the flush door handle, communication from the central control unit to the door handle control unit has a communication transmission delay Td, the process by which the motor of the flush door handle responds to the received signal and drives the mechanical components in the flush door handle to work to deploy the flush door handle has a response delay Tm, and the vehicle collision warning time threshold Ts is determined based on experience or experiments and is preferably set to satisfy the following relationship: Ts>Td+Tm.

More specifically, typically, in the communication network of the whole vehicle, the central control unit where the AEB is located and the control unit of the flush door handle may be on different communication networks, so the control signal from the central control unit is sent to the flush door handle control unit with a communication transmission delay Td of a certain duration. In addition, the process by which the motor responds and drives the mechanical components in the flush door handle to work and deploy the door handle has a response delay Tm. In this case, in order to ensure the smooth implementation of the method of the present application, the vehicle collision time threshold Ts should preferably not be less than the sum of the communication transmission delay Td and the response delay Tm of the motor of the flush door handle.

Further, the process by which the door handle control unit converts the control signal into a corresponding electrical signal and sends it to the motor of the flush door handle typically has a signal processing delay Tp. In this case, the vehicle collision warning time threshold Ts is further preferably set to satisfy the following relationship: Ts>Td+Tm+Tp. That is, the vehicle collision time threshold Ts is preferably not less than the sum of the communication transmission delay Td, the response delay Tm of the motor of the flush door handle, and the signal processing delay Tp.

Advantageously, as shown in FIG. 1, the method of the present application may further comprise:
a collision verification step S30, wherein within a predetermined time window Tw, the state of the vehicle is continuously detected by a sensor mounted on the vehicle (such as an acceleration sensor, vehicle collision sensor, etc.), or signals from the vehicle are continuously acquired that are related to vehicle collision, and thus a judgment is made as to whether a collision of the vehicle has actually occurred; and
a door handle deployed state maintaining step S40, wherein, when it is determined that a vehicle collision has occurred (that is, the judgment result is Y), the flush door handle is maintained in a deployed state; and
a door handle flush state recovery step S50, wherein, when it is determined that no vehicle collision has occurred (that is, the judgment result is N), the operation of the motor of the flush door handle is controlled to recover the flush door handle from the deployed state to the flush state, then returning to the vehicle collision prediction step S10.

It is to be noted that for convenience, in FIG. 1, the collision verification step S30 is shown as being performed after the collision pre-trigger step S20. However, the collision verification step S30 may also be performed concurrently with the collision pre-trigger step S20 where applicable and if necessary.

In other words, according to the method of the present application, a collision verification step S30 may be provided (which may be performed after or simultaneously with the collision pre-trigger step S20 depending on the specific application or practice), wherein after entering the collision verification step S30, based on a preset control algorithm or logic, collision detection may be continuously performed (including to but not limited to by way of an airbag controller) within a predetermined time window Tw, i.e., a certain time range (such as but not limited to within 3 seconds). If a vehicle collision is detected within the time window Tw, the flush door handle may be maintained in the deployed state; in contrast, if a vehicle collision is not detected within the time window Tw, the flush door handle may be restored to the “hidden” state.

Advantageously, the collision verification step S30 may be implemented by the airbag controller of the vehicle and based on signals from an acceleration sensor installed on the vehicle. The airbag controller has a processing delay Tab in the process from sensing the signal change of the acceleration sensor to completing the collision judgment and sending the collision verification signal, and in the collision pre-trigger step S20, the process from the deployment of the flush door handle to the sending of the handle state information has a door handle state transmission delay Tdoor. To ensure the smooth implementation of the method of the present application, the time window Tw is preferably set to satisfy the following relationship: Tw>Ts+Tx, wherein Tx is the larger of the processing delay Tab and the door handle state transmission delay Tdoor.

Advantageously, although not shown in FIG. 1, the method of the present application may also be designed to optionally include a door handle deployed state verification step to perform real-time verification of the current state of the flush door handle (such as but not limited to the current state of the flush door handle being detected by way of a sensor installed on the vehicle or the current state of the flush door handle being determined by obtaining the signal of the motor of the flush door handle), thereby obtaining its actual state and facilitating more reliable and precise control.

More specifically, according to one feasible embodiment of the present application, after the collision verification step S30 and before the door handle deployed state maintaining step S40 or the door handle flush state recovery step S50, the method may further comprise a door handle deployed state verification step, wherein the current state of the flush door handle is verified in real time to confirm the actual state of the flush door handle (i.e., whether it is indeed in a deployed state) and output the door handle state information, for example, through the vehicle network.

In addition, advantageously, after the door handle deployed state verification step, the door handle deployed state maintaining step S40 can be performed in the following manner: when it is determined that a vehicle collision has occurred and the flush door handle is confirmed to be in a deployed state through the door handle state information, the deployed state of the flush door handle is maintained; or when it is determined that a vehicle collision has occurred and the flush door handle is determined to be in a flush state through the door handle state information, it is determined that a vehicle network communication failure has occurred or a flush door handle failure occurred and the method is terminated accordingly.

In addition, advantageously, after the door handle deployed state verification step, the door handle flush state recovery step S50 can be performed in the following manner: when it is determined that no vehicle collision has occurred and the flush door handle is confirmed to be in a deployed state through the door handle state information, the operation of the motor of the flush door handle is controlled to restore the flush door handle from a deployed state to a flush state, then returning to the vehicle collision prediction step S10; or when it is determined that no vehicle collision has occurred and the flush door handle is determined to be in a flush state through the door handle state information, it is determined that the vehicle network communication has failed or the flush door handle has failed and the method is terminated accordingly.

It is clear that the example shown in FIG. 1, as previously noted, is given as an exemplary example for ease of understanding of the present application only and not as a limitation to the present application. For those skilled in the art, it is clear that without departing from the basic principles or technical concepts of the present application, the number, sequence, and specific content of each step in the example shown in FIG. 1 may be appropriately increased, decreased, or changed according to the specific application or actual needs. For example, the detection items, judgment conditions, specific settings of various parameter values, etc. in each step may be appropriately changed or adjusted. For brevity, no more detailed examples are provided here.

It can be seen from the above description that the method of the present application can trigger the deployment of the flush door handle in advance earlier than the prior art within a time window when a vehicle collision may (or is about to) occur but has not actually occurred. Because the collision has not yet occurred at this time, the power supply and communication of the flush door handle are in normal state, thus effectively avoiding the problem that the flush door handle cannot deploy due to power failure.

In addition, according to the method of the present application, after the flush door handle is triggered to deploy, the actual situation of the vehicle collision can be verified. If the vehicle collision is verified to have actually occurred, the flush door handle can continue to be kept in the deployed state; if the vehicle collision is verified to have not actually occurred or is a “false alarm,” the hidden door can be restored to the flush state after a very short time window. By verifying the actual situation of vehicle collision, the method of the present application can effectively reduce the exposure time of erroneous deployment and minimize the occurrence of flush door handle accidental pop-out (or opening) during normal driving.

It can be seen the method of the present application can reliably and conveniently achieve its intended purpose and can solve problems in the prior art such as the flush door handle of a vehicle failing to deploy due to power failure during vehicle collision etc. in a simple, reliable, and low-cost manner.

In addition, the present application also proposes a control unit corresponding to the above method.

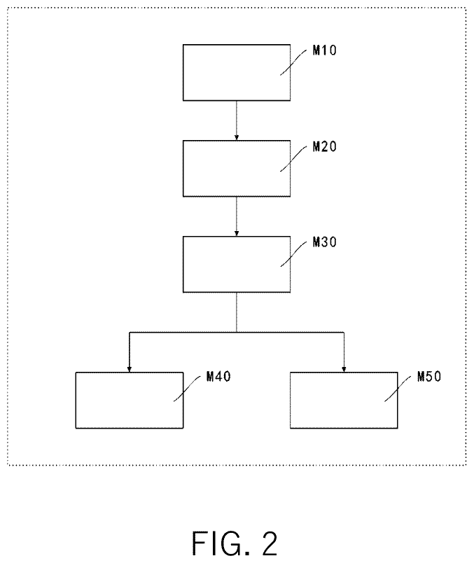

More specifically, as shown in FIG. 2, according to another aspect of the present application, a control unit adapted to implement the method for controlling the deployment of a flush door handle of a vehicle as described above is provided so as to control the deployment of a flush door handle used in a vehicle, wherein the flush door handle is equipped with a motor and the control unit comprises:
a vehicle collision prediction module M10, which is configured in response to the vehicle being started to obtain external vehicle driving information in real time by way of sensors installed on the vehicle and determine if a predetermined vehicle collision risk is present by calculation or if a predetermined vehicle collision risk is present based on a signal from the vehicle associated with the vehicle collision risk; and
a collision pre-trigger module M20, which is configured to trigger the operation of the motor of the flush door handle to transition the flush door handle from the flush state to the deployed state under circumstances where a predetermined vehicle collision risk is determined to be present.

Advantageously, as shown in FIG. 2, the control unit of the present application may further comprise:
a collision verification module M3, which is configured to continuously detect the state of the vehicle by a sensor mounted on the vehicle within a predetermined time window Tw, or to continuously acquire signals from the vehicle that are related to vehicle collision and thus make a judgment as to whether a collision of the vehicle has actually occurred;
a door handle deployed state maintaining module M40, which is configured to maintain the flush door handle in the deployed state when it is determined that a vehicle collision has occurred and the flush door handle is confirmed to be in the deployed state; and
a door handle flush state recovery module M50, which is configured to control the operation of the motor of the flush door handle to restore the flush door handle from the deployed state to the flush state when it is determined that no vehicle collision has occurred and the flush door handle is confirmed to be in the deployed state.

Obviously, the method of the present application (which may also be referred to as the control method) may be performed by way of the control unit of the present application and the various technical features, specific details, and technical effects described for the method are equally applicable to the control unit. Moreover, the various steps and technical details of the method described above can be stored in the control unit in the form of software or implemented by way of a combination of software and hardware. In addition, the control unit of the present application may be integrated in but is clearly not limited to various existing control units (such as but not limited to the vehicle control unit) or controllers in the vehicle.

In addition, according to yet another aspect of the present application, a computer-readable storage medium (that is, a non-temporary computer-readable storage medium) is also proposed, which stores executable instructions (or program instructions), and when the executable instructions are executed by a processor, the processor implements the method for controlling the deployment of a flush door handle of a vehicle as described above.

Additionally, according to another aspect of the present application, a computer program product is also proposed, which comprises a computer program (or instruction), and when the computer program is executed by a processor, the method for controlling the deployment of a flush door handle of a vehicle as described above is implemented.

Accordingly, the present application may provide a computer system comprise a memory, a processor, and a computer program stored in the memory, wherein the processor executes the computer program to implement the method of controlling the deployment of a flush door handle of a vehicle as described above.

The present application has been described in detail in conjunction with specific examples. It is evident, as described above, that the above description and the examples illustrated in the accompanying drawings are to be understood as exemplary and not as limiting the present application. Variations or modifications may be made to the present application by those skilled in the art without departing from the spirit of the present application. Obviously, these variants and modifications do not depart from the scope of the present application.

What is claimed is:

1. A method for controlling deployment of a flush door handle of a vehicle that is suitable for controlling deployment of the flush door handle used in the vehicle, wherein the flush door handle is equipped with a motor, wherein the method comprises:
a vehicle collision prediction step, wherein in response to the vehicle being started, external vehicle driving information is obtained in real time by way of sensors installed on the vehicle and it is determined if a predetermined vehicle collision risk is present by calculation or if a predetermined vehicle collision risk is present based on a signal from the vehicle associated with the vehicle collision risk; and
a collision pre-trigger step, wherein operation of the motor of the flush door handle is triggered to transition the flush door handle from the flush state to the deployed state under circumstances where a predetermined vehicle collision risk is determined to be present.

2. The method according to claim 1, wherein the vehicle collision prediction step comprises:
calculating the expected time to collision TTC based on the relative distance and relative velocity between the vehicle and another vehicle or obstacle and comparing the expected time to collision TTC to a preset vehicle collision warning time threshold Ts and determining that a predetermined vehicle collision risk is present when the expected time to collision TTC is less than or equal to the vehicle collision warning time threshold Ts.

3. The method according to claim 2, wherein the vehicle collision prediction step is implemented by way of a central control unit of the vehicle, the collision pre-trigger step is implemented by way of a door handle control unit of the flush door handle, communication from the central control unit to the door handle control unit has a communication transmission delay Td, the process by which the motor of the flush door handle responds to the received signal and drives the mechanical components in the flush door handle to work to deploy the flush door handle has a response delay Tm, and the vehicle collision warning time threshold Ts is determined based on experience or experiments and is set to satisfy the following relationship: Ts≥Td+Tm.

4. The method according to claim 3, wherein the process by which the door handle control unit converts the control signal into a corresponding electrical signal and sends it to the motor of the flush door handle has a signal processing delay Tp and the vehicle collision warning time threshold Ts is set to satisfy the following relationship: Ts≥Td+Tm+Tp.

5. The method according to claim 2, wherein the method further comprises:
a collision verification step, wherein within a predetermined time window, the state of the vehicle is continuously detected by a sensor mounted on the vehicle, or signals from the vehicle are continuously acquired that are related to vehicle collision, and thus a judgment is made as to whether a collision of the vehicle has actually occurred;
a door handle deployed state maintaining step, wherein, when it is determined that a vehicle collision has occurred, the flush door handle is maintained in a deployed state; and
a door handle flush state recovery step, wherein, when it is determined that no vehicle collision has occurred, the operation of the motor of the flush door handle is controlled to recover the flush door handle from the deployed state to the flush state, then returning to the vehicle collision prediction step;
wherein the collision verification step is performed after the collision pre-trigger step or simultaneously with the collision pre-trigger step.

6. The method according to claim 5, wherein the collision verification step is implemented by an airbag controller of the vehicle and based on signals from an acceleration sensor installed on the vehicle, the airbag controller has a processing delay Tab in the process from sensing the signal change of the acceleration sensor to completing the collision judgment and sending the collision verification signal, and in the collision pre-trigger step, the process from the deployment of the flush door handle to the sending of handle state information has a door handle state transmission delay Tdoor, and the time window Tw is set to satisfy the following relationship: Tw≥Ts+Tx, wherein Tx is the larger of the processing delay Tab and the door handle state transmission delay Tdoor.

7. The method according to claim 5, wherein after the collision verification step and the door handle deployed state maintaining step or the door handle flush state recovery step, the method further comprises:
a door handle deployed state verification step, in which the current state of the flush door handle is verified in real time to confirm the actual state of the flush door handle and output the door handle state information through the vehicle network.

8. The method according to claim 7, wherein:
after the door handle deployed state verification step, the door handle deployed state maintaining step is performed in the following manner: in the door handle deployed state maintaining step, when it is determined that a vehicle collision has occurred and the flush door handle is confirmed to be in a deployed state through the door handle state information, the deployed state of the flush door handle is maintained; or when it is determined that a vehicle collision has occurred and the flush door handle is determined to be in a flush state through the door handle state information, it is determined that a vehicle network communication failure has occurred or a flush door handle failure has occurred and the method is terminated accordingly; or
after the door handle deployed state verification step, the door handle flush state recovery step is performed in the following manner: in the door handle flush state recovery step, when it is determined that no vehicle collision has occurred and the flush door handle is confirmed to be in a deployed state through the door handle state information, the operation of the motor of the flush door handle is controlled to recover the flush door handle from a deployed state to a flush state, then returning to the vehicle collision prediction step; or when it is determined that no vehicle collision has occurred and the flush door handle is determined to be in a flush state through the door handle state information, it is determined that the vehicle network communication has failed or the flush door handle has failed and the method is terminated accordingly.

9. A control unit adapted to implement the method for controlling the deployment of a flush door handle of a vehicle according to claim 1 so as to control the deployment of a flush door handle used in a vehicle, wherein the flush door handle is equipped with a motor and the control unit comprises:
a vehicle collision prediction module, which is configured in response to the vehicle being started to obtain external vehicle driving information in real time by way of sensors installed on the vehicle and determine if a predetermined vehicle collision risk is present by calculation or if a predetermined vehicle collision risk is present based on a signal from the vehicle associated with the vehicle collision risk; and
a collision pre-trigger module, which is configured to trigger the operation of the motor of the flush door handle to transition the flush door handle from the flush state to the deployed state under circumstances where a predetermined vehicle collision risk is determined to be present.

10. The control unit according to claim 9, wherein the control unit further comprises:
a collision verification module, which is configured to continuously detect the state of the vehicle within a predetermined time window Tw by a sensor mounted on the vehicle, or to continuously acquire signals related to vehicle collision from the vehicle and thereby determine whether a vehicle collision has actually occurred;
a door handle deployed state maintaining module, which is configured to maintain the flush door handle in the deployed state when it is determined that a vehicle collision has occurred and the flush door handle is confirmed to be in the deployed state; and
a door handle flush state recovery module, which is configured to control the operation of the motor of the flush door handle to recover the flush door handle from the deployed state to the flush state when it is determined that no vehicle collision has occurred and the flush door handle is confirmed to be in the deployed state.

11. A computer program product comprising a computer program, wherein when the computer program is executed by a processor, the method for controlling the deployment of a flush door handle of a vehicle according to claim 1 is implemented.

12. A computer-readable storage medium having executable instructions stored thereon, which, when executed by a processor, cause the processor to perform the method for controlling the deployment of a flush door handle according to claim 1.
